(19) United States
(12) Patent Application Publication
(10) Pub. No.: US 2005/0280583 A1
(43) Pub. Date: Dec. 22, 2005

(54) Antenna for television phone

(76) Inventor: Eung-Soon Chang, Seoul (KR)

Correspondence Address: COLEMAN SUDOL SAPONE, P.C., 714 COLORADO AVENUE, BRIDGE PORT, CT, 06605-1601, US

(21) Appl. No.: 10/530,229

(22) PCT Filed: Mar. 25, 2003
(86) PCT No.: PCT/KR03/00584

§ 371 Date: Aug. 12, 2005

(30) Foreign Application Priority Data
Nov. 29, 2002 (KR) 10-2002-0075162

(51) Int. Cl. H01Q 1/24

(52) U.S. Cl. 343/702; 343/725

(57) ABSTRACT

An improved antenna for a television phone which is capable of enhancing a signal receiving degree of a television broadcasting signal, even when a television phone is stopped or is being moved, by extending a length of an antenna by forming a rod antenna in multiple stages. The rod antenna includes an insulation section in which a knob is formed, a multiple-stage rod section which is formed of multiple stages which perform a signal spreading function for an electric wave transmission and receipt function, and a conductive lower section which is connected with the rod section of a first stage of the multiple stage rod section and electrically contacts with a metal bushing of the helical antenna when the insulation section and multiple stage rod section are extended.

### BACKGROUND OF THE INVENTION

1. Field Of The Invention

The present invention relates to an antenna for a television phone, and in particular to an improved antenna for a television phone which is capable of enhancing a signal receiving degree of a television broadcasting signal even when a television phone is stopped or is being moved by extending a length of an antenna by forming a rod antenna in multiple stages in a portable television antenna formed of a rod antenna and a helical antenna.

2. Description Of The Background Art

Recently, a personal information communication portable terminal is advanced in a type that a cellular phone is incorporated in a palm top computer or a PDA for thereby performing various multimedia including a wireless internet communication. In particular, the above terminal is capable of performing a customer management function, a telephone number note function, an e-mail transmission and receipt function, and a character information character and receipt function such as news.

In addition, a television phone which is capable of receiving a television broadcasting signal which is a basic function of a media communication and performing a wireless telephone function is being rapidly advanced together with a personal information communication movable terminal.

FIG. 1 is a block diagram illustrating a conventional television phone which includes an antenna section 10 which is formed of a rod antenna and a helical antenna and is adapted to receive a television broadcasting signal and to transmit and receive a wireless telephone signal, a television broadcasting receiving section 20 which is adapted to select and modulate a television broadcasting signal received from the antenna section 10, a wireless telephone transmitting and receiving section 30 which is adapted to convert a wireless telephone signal from the antenna section 10 into a digital or analog form for thereby processing signals, a speaker 40 which is adapted to output an audio signal of the television broadcasting signal and outputs an audio signal of the wireless telephone, a microphone 50 which is adapted to input an audio signal of a user for implementing a wireless telephone communication, a display section 60 which is adapted to display a video of the television signal and various information and control states, a key pad 70 which is adapted to set various control modes. for a television broadcasting and wireless telephone communication, a power section 80 which is adapted to supply an operational power to each element, and a control section 90 which is adapted to control the overall operations of each element.

In the thusly constituted television phone, as a wireless telephone signal and television broadcasting signal are received through the antenna section 10, a communication of a wireless telephone and a watching of a television broadcasting are implemented.

Namely, a wireless telephone function is performed by operating a helical antenna of the antenna section 10, and a television watching function is performed by operation both the helical antenna and rod antenna of the antenna section 10.

However, in the conventional television phone, since the antenna section 10 of the television phone uses an antenna of a conventional wireless phone, when receiving a television broadcasting frequency which is lower than a frequency of a wireless phone, the signal receiving degree is significantly decreased when the wireless phone is stopped or is being moved.

### SUMMARY OF THE INVENTION

Accordingly, it is an object of the present invention to provide an antenna for a television phone which overcomes the problems encountered in the conventional art.

It is another object of the present invention to provide an antenna for a television phone which is capable of enhancing a signal receiving degree of a television broadcasting signal even when a television phone is stopped or is being moved by extending a length of an antenna by forming a rod antenna in multiple stages in a portable television antenna formed of a rod antenna and a helical antenna.

In order to achieve the above objects, in an antenna for a portable television phone formed of a rod antenna and a helical antenna, there is provided a rod antenna for a television phone which includes:

an insulation section in which a knob is formed;

a multiple stage rod section which is formed of multiple stages which perform a signal spreading function for an electric wave transmission and receipt function; and

a conductive lower section which is connected with the rod section of a first stage of the multiple stage rod section and electrically contacts with a metal bushing of the helical antenna when the insulation section and multiple stage rod section are extended.

In addition, in the multiple stage rod section of the rod antenna, the rod section of each stage is inserted into the interior of the rod section of the next stage and is extended or received therein.

### BRIEF DESCRIPTION OF THE DRAWINGS

The present invention will become better understood with reference to the accompanying drawings which are given only by way of illustration and thus are not limitative of the present invention, wherein;

FIG. 1 is a block diagram illustrating a conventional television phone;

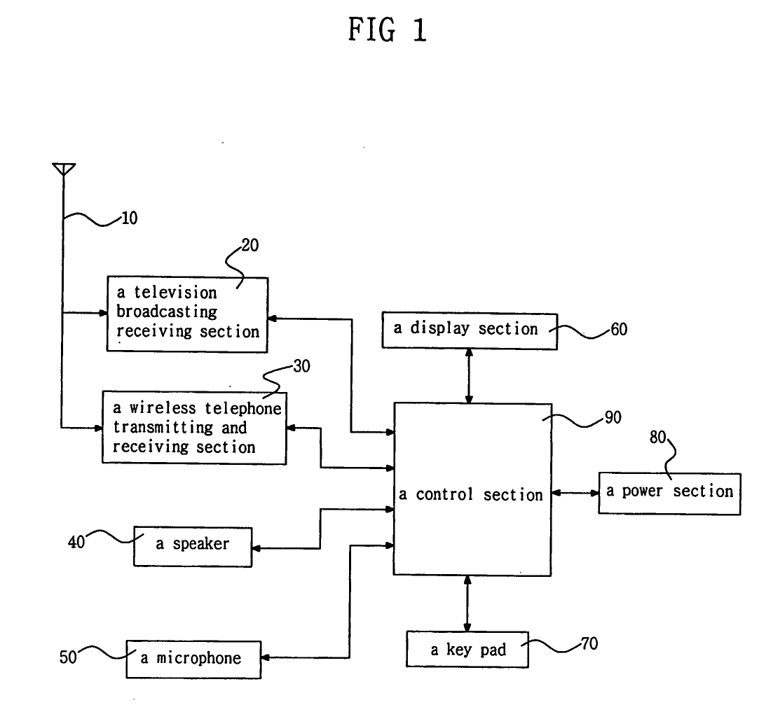

FIG. 2 is a view illustrating an antenna for a television phone according to an embodiment of the present invention; and

FIG. 3 is a disassembled view illustrating an antenna for a television phone according to an embodiment of the present invention.

### DESCRIPTIONS OF REFERENCE NUMERALS OF MAJOR ELEMENTS OF THE DRAWING

11: insulation section
12: helical antenna
13: first rod section
14: second rod section
15: third rod section
16: lower section

### DETAILED DESCRIPTION OF THE PREFERRED EMBODIMENTS

The constructions and operations of an antenna for a television phone according to the present invention will be described with reference to the accompanying drawings.

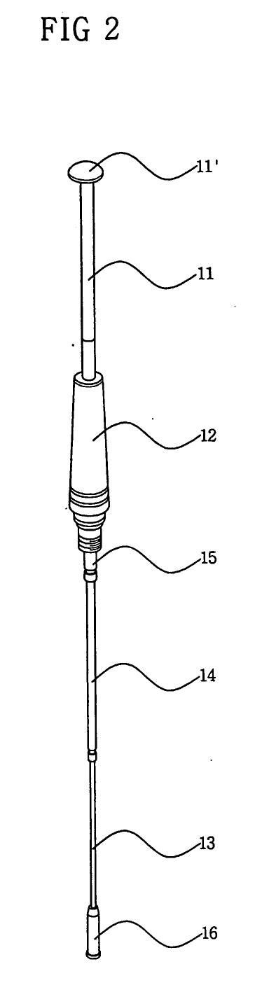

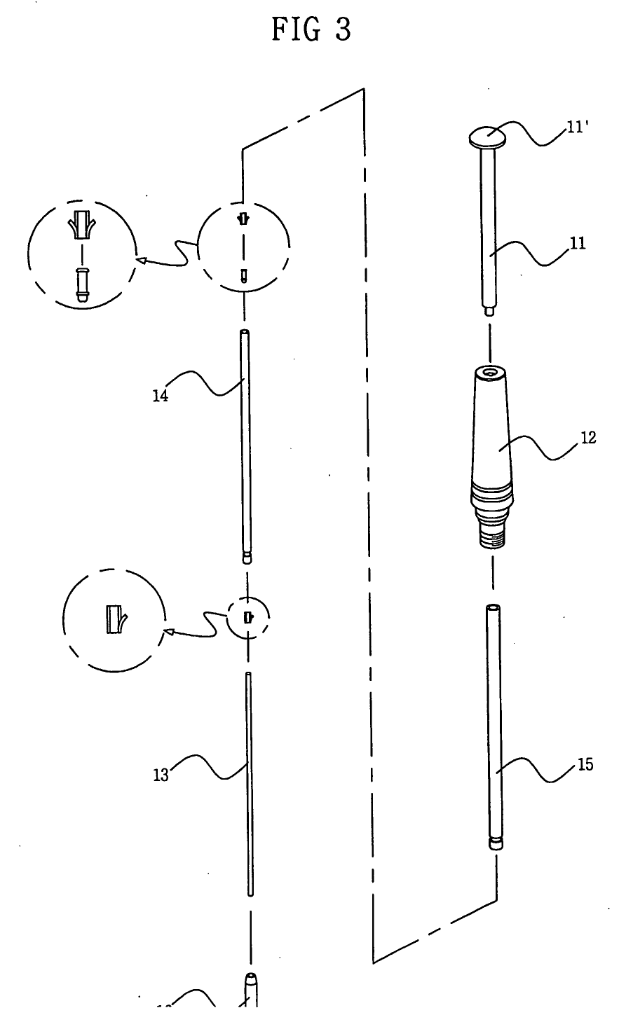

FIG. 2 is a view illustrating an antenna for a television phone according to an embodiment of the present invention, and FIG. 3 is a disassembled view illustrating an antenna for a television phone according to an embodiment of the present invention. As shown therein, a television phone antenna according to the present invention includes an insulation section 11, a first rod section 13, a second rod section 14, a third rod section 15 and a lower section 16.

Namely, the helical antenna 12 is formed of a screw shaped helical antenna(not shown) which is formed in a cylindrical housing and is adapted to perform a signal spreading function for a wave transmission and receipt operation in the interior of a housing, and a metal bushing(not shown) which is adapted to electrically contact with the helical antenna and is elastically connected to a body of a television phone.

In addition, the rod antenna includes an insulation section 11 in which a knob 11′ is formed, first through third rod sections 13 through 15 which perform a signal spreading function for an electric wave transmission and receipt operation, and a conductive lower section 16 which is electrically contacted with a metal bushing of the helical antenna 12 when the insulation section 11 and the first through third rod sections 13 through 15 are extended.

The insulation section 11 is connected with the third rod section 15, and the insulation section 11 and the first through third rod sections 13 through 15 are inserted in the interior of the cylindrical housing of the helical antenna 12 and are extended or shortened therein, and the first through third rod sections 13 through 15 are constituted in such a manner that the first rod section 13 is inserted into the interior of the second rod section 14 and is extended and shortened therein. The second rod section 14 is inserted into the interior of the third rod section 15 and is extended and shortened therein, so that actually the rod antenna is formed in multiple stages.

Here, the first rod section 13 is formed o a NI/TI wire which is a shape memory alloy and is designed in order for the same not to be flexed, and the second rod section 14 and the third rod section 15 are preferably formed of a stainless pipe. The material of the same is not limited thereto.

The rod antenna is formed in three stages, so that it is extendable at three stages in a small receiving space, whereby it is possible to extent the length of the antenna.

Therefore, in the case of the television phone, when receiving a television broadcasting frequency which is lower than a frequency of the wireless phone, it is well adapted for a television antenna for receiving a frequency of a television broadcasting.

In the television phone which includes the thusly constituted antenna, the operations of the antenna and television phone according to the present invention will be described. In a state that the rod antenna is received, the lower section 16 of the rod antenna is in a deep portion of the interior of the television phone, so that it does not electrically contact with a metal bushing of the helical antenna 12, so that w wireless phone function is performed through the television phone based on the operation of the helical antenna 12. In a state that the rod antenna is extended, the third, second and first rod sections 15, 14 and 13 of the rod antenna are upwardly extended one by one, so that the lower section 16 electrically contacts with a metal bushing of the helical antenna 12, whereby the rod antenna and helical antenna 12 all operate for thereby performing a television broadcasting watching function through a television phone in a state that the length of the antenna is extended.

In the television phone antenna according to a preferred embodiment of the present invention, the rod antenna is preferably formed at three stages. In another preferred embodiment of the present invention, it is possible to fabricate a rod antenna in four or five stages based on the volume of a space for receiving the rod section therein.

As described above, in the mobile television antenna formed of a rod antenna and helical antenna according to the present invention, the rod antenna is formed of a multiple-stage rod section formed of multiple stages, and the rod section of each stage is formed in such a manner that the same is inserted into the interior of the rod section of the next stage and is extended or received therein for thereby extending the length of the antenna. Therefore, it is possible to enhance a signal receiving degree of a television broadcasting signal even when the terminal is stopped or is being moved. In addition, it is possible to expect a wide use of the television phone.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An antenna for a portable television phone formed of a rod antenna and a helical antenna, said rod antenna for a television phone comprising:
an insulation section in which a knob is formed;
a multiple-stage rod section which is formed of multiple stages which perform a signal spreading function for an electric wave transmission and receipt function; and
a conductive lower section which is connected with the rod section of a first stage of the multiple stage rod section and electrically contacts with a metal bushing of the helical antenna when the insulation section and multiple stage rod section are extended.

2. The antenna of claim 1, wherein said multiple stage rod section is formed of a rod section of more than three stages.

3. The antenna of claim 1, wherein said insulation section of the rod antenna is connected with the rod section of the last stage of the multiple stage rod section, and said insulation section and multiple stage rod section are inserted into the interior of a cylindrical housing of the helical antenna for thereby being extended or received therein.

4. The antenna of claim 1, wherein in said multiple stage rod section of the rod antenna, the rod section of each stage is inserted into the interior of the rod section of the next stage and is extended or received therein.

5. The antenna of claim 1, wherein a material of the rod section of the first stage of the multiple stage rod section of the rod antenna is a NI/TI wire which is a shape memory alloy.
